(19) United States
(12) Patent Application Publication
(10) Pub. No.: US 2014/0015645 A1
(43) Pub. Date: Jan. 16, 2014

(54) Apparatus and Method for Providing Product Information

(71) Applicant: The Gillette Company, Boston, MA (US)

(72) Inventors: Grant Edward Striemer, Hamilton, OH (US); Jonathan Livingston Joyce, Independence, KY (US); Mathias Amann, Darmstadt Hessen (DE); Faiz Feisal Sherman, Mason, OH (US); Michael Franke, Darmstadt (DE); Jordan Todorov Bourilkov, Bethany, CT (US); Mark Wayne Morrow, Milford, OH (US); Jose Tadeo Vergara DeCastro, Newton, MA (US); Stephan James Andreas Meschkat, Bad Soden Hessen (DE)

(73) Assignee: The Gillette Company, Boston, MA (US)

(21) Appl. No.: 14/025,869

(22) Filed: Sep. 13, 2013

Related U.S. Application Data
(63) Continuation-in-part of application No. 13/616,428, filed on Sep. 14, 2012.
(60) Provisional application No. 61/580,379, filed on Dec. 27, 2011.

(51) Int. Cl. G06K 7/10; G06K 19/077

(52) U.S. Cl. CPC G06K 7/10366; G06K 19/07773
USPC 340/10.1; 235/488; 235/439

(57) ABSTRACT

A sensor system comprising a tag. The tag comprises at least one radio-frequency chip, a first antenna disposed in electrical communication with the chip and a non-conductive coating disposed upon a surface of the tag. The chip comprises a memory element providing electrical storage of a binary coded word comprising at least one bit and output terminals. The antenna is in electrical communication with the output terminals. The non-conductive coating covers the chip and defines a perimeter. The perimeter is disposed over and exposes a portion of the antenna.

### FIELD OF THE INVENTION

The invention relates to systems and methods for determining information about a product. The invention relates particularly to the remote interrogation of product information and the subsequent use of the acquired information.

### BACKGROUND OF THE INVENTION

Consumable goods having a useful life defined in terms of the consumption of the goods are well known. The useful life may be viewed as one or more events associated with the consumption of at least a portion of the useful quantity of the goods. In formation associated with the environment of use of the goods and/or the quantity of goods used and remaining available may exist but may also be generally inaccessible to the typical consumer of the goods. What is needed is a system and method for extracting product relevant information in a manner which makes the information readily accessible and usable by the consumer.

### SUMMARY OF THE INVENTION

In one aspect, A sensor system comprising a tag. The tag comprises at least one radio-frequency chip, a first antenna disposed in electrical communication with the chip and a non-conductive coating disposed upon a surface of the tag. The chip comprises a memory element providing electrical storage of a binary coded word comprising at least one bit and output terminals. The antenna is in electrical communication with the output terminals. The non-conductive coating covers the chip and defines a perimeter. The perimeter is disposed over and exposes a portion of the antenna.

In one aspect a method of determining product information includes the steps of: providing a product comprising a tag, and an interrogator adapted to detect radiation associated with the data of the tag; interrogating the state of the tag; interpreting the state of the tag; and providing an output associated with the interpreted state of the tag. The tag comprises a digital memory storing data associated with the product.

### BRIEF DESCRIPTION OF THE DRAWINGS

Further features and benefits of the present invention will become more readily apparent through consideration of the drawings.

FIG. 1 shows a schematic representation of one embodiment of the invention.

FIG. 2 show s a schematic representation of one embodiment of the invention.

FIG. 3 shows a schematic representation of one embodiment of the invention.

### DETAILED DESCRIPTION OF THE INVENTION

Definitions:

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

A “chip” as described herein, may be supplanted by a chipless RFID element as is known in the art. An LC resonant RF tag, or a multiresonator element may be used in place of the chip in the described embodiments.

In one aspect, a sensor system comprising a tag. The tag may comprise one or more layers of conductive inks printed upon a substrate. Exemplary substrate materials include: polyester, paper, high permittivity dielectric materials, and FR-4 material Multiple layer structures may further comprise partial layers of non-conducting material separating at least portions of the conductive layers. Exemplary conductive layers include copper and silver inks. The tag comprises a radio-frequency chip, and a first antenna disposed as a circuit upon a card, coin, or inlay. The chip may be an active or passive chip. Exemplary chip/first antenna combinations include model numbers: RI-I03-112A-03 (13.56 MHz), and RI-INL-R9QM (134.2 kHz), or model TRF7970A, each available from Texas Instruments, Dallas, Tex. The antenna may be in the physical form of a coil or a dipole. The chip/first antenna combination may be integrated into a unit tag available from Kovio, San Jose, Calif.

The tag further comprises an outer non-conductive coating. Exemplary non-conductive coating materials include polypropylene, polyethylene, and polyethylene terephthalate. The coating is disposed upon a surface of the tag such that a portion of the tag is uncoated and exposed to the environment of the tag. The uncoated area is defined by a perimeter of the non-conductive coating. The exposed portion of the tag may comprise a portion of the antenna up to and including all of the antenna.

In one embodiment, the circuit configuration of the chip and antenna includes a gap such that the circuit is incomplete. In this embodiment, the gap remains exposed to the environment rather than being protected by the non-conductive coating. The circuit of the tag may be completed by exposing the tag to a conductive environment such that conductive material provides the necessary electrical conductivity across the gap. Conductive environments include conductive gels, powders or liquids wherein the gap is bridged by the conductive substance. Urine, blood and salt water are each conductive. Gels or powders comprising electrolytes would also constitute conductive materials.

The tag may be read using an radio frequency protocol such as the Near Field Communications (NFC) protocol. When the tag is interrogated, or read, the tag circuit is powered. The memory of the tag is then read by an interrogator.

The sensor system may further comprise an interrogator. The interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation. The Bluetooth™ RFID Reader, model number 223012, available GAO RFID, of Toronto Canada, exemplifies one form of interrogator. The model 223012 interrogator has the capacity to interrogate the radio frequency tag and to determine the state of the memory of the tag and thus extract information associated with the output of the sensor or sensors relating to the environment of the tag. The 223012 further comprises a secondary network communications link utilizing the Bluetooth™ communications protocol for transmitting the information extracted from the tag to a secondary device or secondary interrogator, such as a Bluetooth™ enabled computer or smart phone. The secondary interrogator may further analyze the information relating to the state of the tag and/or the tags environment and provide an output associated with a particular tag and/or tag environment state. The interrogator may further comprise a display element such as an LCD or LED screen for displaying an output associated with the analyzed tag information. The interrogator may further comprise one or more sensors for ascertaining information associated with the environment of the interrogator. The sensors may include: temperature, humidity, acceleration sensors. The interrogator may further comprise one or more cameras enabling the capture of images associated with a product, the tag or the environment. The interrogator may comprise a Global Positioning capability enabling the interrogator to ascertain and share information relating to the geographic location of the interrogator.

In one aspect, the Smartphone may serve as the only interrogator. In this aspect the smart phone may interrogate the tag thereby ascertaining the information from the memory of the tag. The interrogator may analyze or otherwise interpret the information and may create an output. The output may be provided to a system user via an audio output, visual output, haptic output or combinations thereof. The interrogator may utilize inputs from sensors or systems of the Smartphone in addition to the tag information in creating the output. Exemplary smart phones suitably configured to perform as a system interrogator include: the Acer™ E320 Liquid Express, the Blackberry™ Bold™ 970, available from Research In Motion of; the Casio IT-800; the Google Nexus 7™, available from Google, Inc. Mountain View Calif.; the HTC Desire C™, available from HTC of; the LG Optimus Elite; the Motorola Droid™ Razr™, available from Motorola; the Nokia 700; the Panasonic BizPad™; and the Samsung Galaxy S Advance™.

In one aspect, the sensor system may include a product. The term “product(s)” is used in the broadest sense and refers to any product, product group, services, communications, entertainment, environments, organizations, systems, tools, and the like. For example, an example of a product group is personal and household products, such as used by a person, family or household. Examples of a representative, and non-limiting list of product categories within the personal and household product group includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, laundry, oral care, paper products, personal cleansing, disposable absorbent articles, pet health and nutrition, prescription drugs, prestige fragrances, skin care, foods, snacks and beverages, special fabric care, shaving and other hair growth management products, small appliances, devices and batteries, services such as haircutting, beauty treatment, spa treatment, medical, dental, vision services, entertainment venues such as theaters, stadiums, as well as entertainment services such as film or movie shows, plays and sporting events A variety of product forms may fall within each of these product categories.

Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap.

Exemplary health care products include laxatives, fiber supplements, oral and topical analgesics, gastro-intestinal treatment products, respiratory and cough/cold products, heat delivery products, and water purification products. Exemplary paper products include toilet tissues, paper towels, and facial tissues. Exemplary hair care products include shampoos, conditioners (including rinse-off and leave-in forms), and styling aids. Exemplary household care products include sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, micro-dermabrasion and peel products, skin rejuvenation products, anti-aging products, masks, UV protection products, and skin care puffs, wipes, discs, clothes, sheets, implements and devices (with or without skin care compositions).

Other product groups include but are not limited to: sports equipment, entertainment (books, movies, music, etc), vision, and in-home-consumed medical and first aid, among others.

The tag may be attached to the packaging of the product such as the primary packaging of a liquid product, or a granular product. The tag may be immersed in or float upon the surface of a packaged liquid or granular product. The tag may be incorporated within the product such as within a disposable absorbent article such as within a diaper for the purpose of detecting an insult to the absorbent core of the diaper. The tag may be disposed upon the surface of the product itself.

It is believed that conforming the antenna of the tag to the shape of the outer surface of the product yields a system where communication between the interrogator and the tag may be omni-directional or achievable at a variety of angles between the interrogator and the tag.

One of the problems associated with creating a communication device for various products is realized when the communication device is utilized on conductive bodies. Free space radio propagation principles do not apply near highly conductive bodies. Additionally, antenna performance is severely degraded when antennas are placed near metals. As such, simply placing an RFID tag on a battery or on an object with a conductive body may not accomplish the desired effect, e.g. data transfer. Notably, this problem is not limited to rechargeable/disposable batteries. For example, a can of shaving gel, foam, etc., or a package comprising a metalized film, could experience the same issues because of the conductivity of the container. In general, an RFID tag next to metallic body decreases signal coupling between the reader and the tag by 10×.

One way to prevent the effects arising from metal proximity to the antenna is to prevent the electromagnetic field from entering the metal. For example, by placing a material with suitable electromagnetic properties 5 and dimensions between the antenna and the metal surface the electromagnetic field may be diverted around the metallic/conductive body of the product. The properties of the diverter material depend on the exact metal used and the RFID frequency. The magnetic diverter effectively isolates the tag from the can.

In one aspect, a method of determining product information comprises steps of: providing a product comprising a tag as described above. The tag comprising, at least one sensor adapted to provide an output analogous to a change in an environment of the sensor. The sensor having at least one output terminal. The tag also includes a radio-frequency chip comprising a memory element, input terminals and output terminals, and a first antenna disposed in electrical communication with the output terminals of the chip.

The method also includes providing an interrogator adapted to detect radiation associated with the data of the tag. The interrogator may be an RF or NFC protocol reader coupled with a Bluetooth™ capability as described above, or a smart phone or other computing device comprising an RF, possibly NFC, capable reader.

The interrogator may be used to determine the current state of the tag utilizing an RF communications protocol such as the NFC protocol. The interrogator may interpret the data received from the tag using a software application written for that purpose.

In one aspect the method may be minimized to providing products including tags and providing software compatible with devices available in the market or in the possession of consumers. A consumer may choose to avail themselves of the application software which will enable their device to functions as the described interrogator.

In one embodiment, the tag may be used to convey the amount of a product remaining within a package. In this embodiment, the tag may be configured with a portion of the antenna exposed such that exposure to a conductive product will short circuit the tag rendering it inoperative until the exposed portion of the tag is free of the product due to a drop in the level of the product with respect the tag. Alternatively, the tag may be configured such that the perimeter of the non-conductive coating exposes a gap in the circuit. In this embodiment, the tag will be readable as long as the gap is bridged by the presence of conductive product and will not be readable in the absence of product.

In one embodiment, a dipole antenna may be coated with a non-conductive polymer. The coating may include a series of gaps exposing the antenna leads to the environment of the tag. In this embodiment, the conductivity of the tag antenna will change as more or fewer gaps are covered with a conductive fluid. The conductivity change may be predetermined and the purpose of the interrogation may be to ascertain the current state of the antenna conductivity as an indicator of fluid contact—i.e. level with respect to the tag/antenna.

An absorbent article may include a tag such that the interrogator will only receive an output when the product/tag has been insulted by use and the exposed portion of the tag circuit has come into contact with a conductive fluid such as blood or urine. Alternatively, the product tag may be configured to provide an output to the interrogator until the product has been used/insulted and the tag has been shorted out by the exposure.

In one embodiment the tag may comprise a combination of the two configurations described above. In this embodiment, a first chip will be readable only in the absence of product while a second chip will be readable only in the presence of product. This embodiment provides the benefit of always providing an output to the interrogator regardless of the state of the product quantity.

A tag comprising a dual read configuration described above may be included within a diaper or other absorbent product. In this example, the tag will provide an output to the interrogator in both an insulted state and a non-insulted state. The user will receive information regarding the state of the product and will not be left in doubt as to whether the product state has changed or if there is an issue with the tag.

In one aspect, the interrogator may incorporate a secondary network communication module affording the device an ability to send and receive data over a cellular phone or other networks including a local area or WiFi networks. In such an aspect, the interrogator may transmit data received from the tag and/or an analysis of the data from the tag. The software application of the interrogator may analyze the data from the tag to determine if replenishment of the product associated with the tag in needed, or to project when such replenishment will be needed in view of usage history of the product established via a series of interrogations of the tag. In this aspect the application may be used to consummate a purchase of addition product via the network. The application may be further utilized to offer the user related products for purchase, or to make offers of other products not directly related to the product.

In one embodiment, the system tag may be subdivided into portions. One portion may contain at least a portion of the antenna and the chip, the other portion may contain the conductive polymer system and any remaining portion of the antenna. The two portions of the tag may be disposed with the antenna and non-conductive coating exposed to the functional environment of an absorbent article, and the chip portion removed from exposure to the functional environment of the article. The chip portion may be made removable and therefore reusable as well. The sensor may be made removable while the antenna and chip portion is retained in the product. In one embodiment, a removable sensing element may be coupled to a resident chip/antenna element. As an example, a personal care device such as a shaver or oral care implement, may be constructed with a resident antenna and chip with contacts enabling the insertion use and removal of a sensing element. The sensing element may be removed for disposal or replacement or cleaning and reinstallation. In one embodiment, conductive hook and loop fasteners, such as are available from APLIX Inc., of Charlotte, N.C., may be used to create an interface between the functional environment of the article and the exterior of the article. The attachment mechanism between the article, sensor and the removable tag to enable conductivity can be hook & loop, compression (e.g. elastic band, garter), adhesion (e.g. adhesive strip), magnetic, or combinations thereof. In this embodiment, the antenna and non-conductive coating system may be fabricated as an assembly in electrical contact with the conductive hook and loop pads which in turn are disposed upon an exterior surface of the article while the antenna and non-conductive coating are disposed within the interior of the article. Matching pads may be incorporated as part of the assembly of the chip assembly and the two respective assemblies may be united using the matching hook and loop pads for operational use of the tag. In this manner, the more costly chip assembly may be rendered reusable thereby reducing the overall cost associated with using the system with a number of respective disposable articles. The respective assemblies may be formed using conductive adhesive, such as is available from MG Chemicals, of Surrey, B.C., Canada to affix the electrical leads of the respective portions of the tags to their respective hook and loop fastener pads.

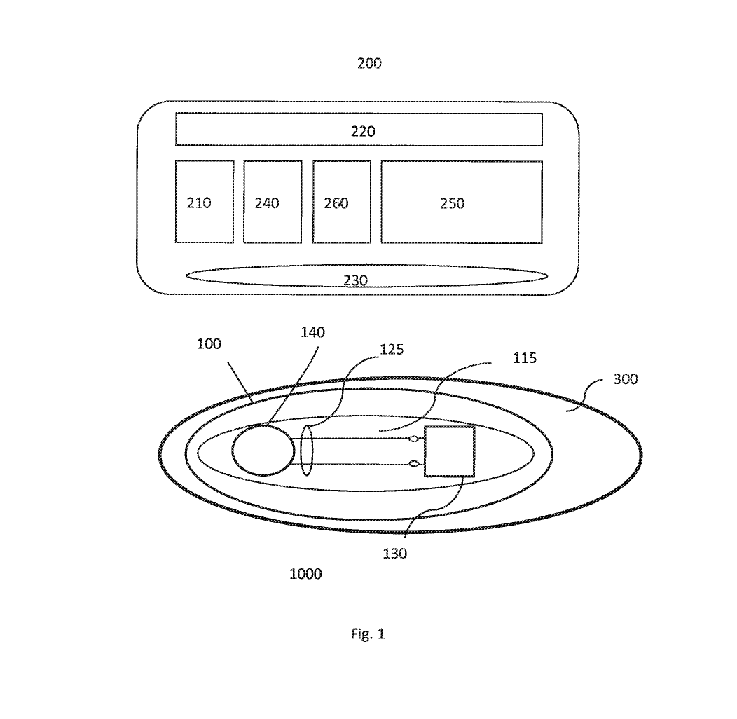

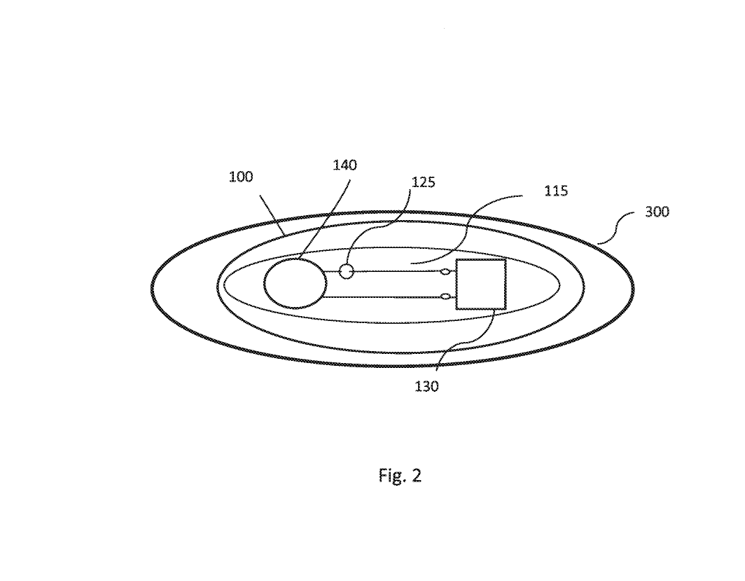

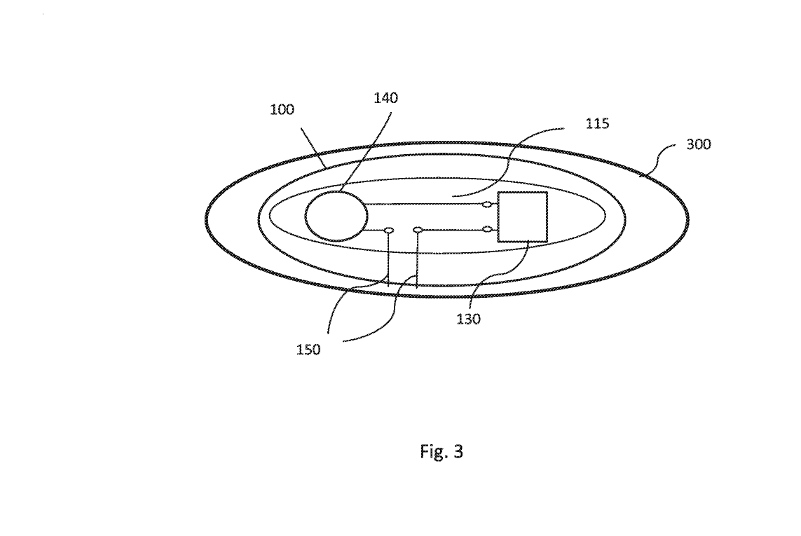

As shown in FIG. 1, a system 1000, comprises an absorbent article 300, and an interrogator 200. The absorbent article 300 comprises a tag 100. The tag 100 comprises a removable chip 130, a non-conductive coating 115, which defines a perimeter 125, and an antenna 140. The interrogator 200 comprises a sensor 210, a power source 220, an antenna 230, an analysis element 240, a display element 250, and a network link 260. As shown in FIG. 2, the absorbent article 300 comprises a tag 100. The tag 100 comprises a removable chip 130, a non-conductive coating 115, which defines a perimeter 125, and an antenna 140. As shown in FIG. 3, the absorbent article 300 comprises a tag 100. The tag 100 comprises a removable chip 130, a non-conductive coating 115, conductive leads 150, and an antenna 140.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sensor system comprising a tag, the tag comprising:
a. at least one removable radio-frequency chip and output terminals;
b. a first antenna disposed in electrical communication with the output terminals of the chip,
c. a non-conductive coating disposed upon a surface of the tag, the coating covering the chip and defining a perimeter, the perimeter disposed over and exposing a portion of the antenna.

2. The sensor system of claim 1 further comprising an interrogator comprising a power source and a second antenna adapted to generate electromagnetic radiation comprising a resonant frequency of the first antenna, and a receiver adapted to detect electromagnetic radiation and de-modulate the detected radiation extracting embedded data from the detected radiation.

3. The sensor system of claim 2 wherein the interrogator further comprises: an analysis element adapted to interpret the extracted embedded data, and a display element adapted to display the results of the interpretation.

4. The sensor system of claim 2 wherein the interrogator further comprises a sensor.

5. The sensor system of claim 2 wherein the interrogator comprises a network communications link.

6. The sensor system of claim 1 wherein the first antenna comprises an omni-directional antenna.

7. The sensor system of claim 1 further comprising a product wherein the tag comprises part of a product.

8. The sensor system according to claim 7 wherein the product comprises a disposable absorbent article.

9. The sensor system according to claim 7 wherein the product comprises a portable power source.

10. The sensor system of claim 7 further comprising electrical shielding disposed between the antenna and product.

11. The sensor system of claim 10 wherein the shielding comprises part of the tag.

12. The sensor system of claim 1 wherein the antenna comprises a coil.

13. The sensor system of claim 1 wherein the antenna comprises a dipole.

14. The sensor system of claim 1 wherein the exposed antenna portion comprises antenna leads between connected to the chip.

15. The system of claim 1 wherein the exposed portion of the antenna comprises a non-conductive gap in a coil of the antenna.

16. The system according to claim 1 wherein the tag comprises a passive radio frequency chip.

17. A method of determining product information, the method comprising steps of:
a. providing a product comprising a tag, the tag comprising a partially exposed antenna and a removable chip;
b. providing an interrogator adapted to detect radiation associated with an environmental state of the tag;
c. altering the environmental state of the tag with respect to the environment of the exposed antenna portion;
d. interrogating the state of the tag after the environment of the exposed portion of the antenna has been altered;
e. interpreting the state of the tag;
f. providing an output associated with the interpreted state of the tag.

18. The method according to claim 17 wherein the step of providing an interrogator further comprises providing an interrogator comprising a network communications link, the method further comprising a step of sharing data associated with the state of the tag over a network.

19. The method according to claim 18 further comprising the step of sharing data from the interrogator sensor over the network.

20. The method according to claim 18 further comprising the step of purchasing a unit of the product using the network.
